(19) United States
(12) Patent Application Publication
(10) Pub. No.: US 2012/0321840 A1
(43) Pub. Date: Dec. 20, 2012

(54) THREE-DIMENSIONAL WORKPIECE

(75) Inventors: Jung-Chin Wu, Taipei City (TW); Po-An Lin, Taipei City (TW); Kuo-Nan Ling, Taipei City (TW); Han-Ching Huang, Taipei City (TW); Wan-Li Chuang, Taipei City (TW)

(73) Assignee: COMPAL ELECTRONICS, INC., Taipei City (TW)

(21) Appl. No.: 13/517,559

(22) Filed: Jun. 13, 2012

Related U.S. Application Data
(60) Provisional application No. 61/497,033, filed on Jun. 14, 2011.

(51) Int. Cl. B32B 3/24; B32B 3/12

(52) U.S. Cl. 428/116; 428/138

(57) ABSTRACT

A three-dimensional workpiece including a first ductile plate, a second ductile plate and a core layer is provided. The core layer is located between the first ductile plate and the second ductile plate. The first ductile plate, the second ductile plate and the core layer are bound together and have a three-dimensional shape. The first ductile plate has a flat area and a curved area. The core layer has a core flat area and a core curved area. The core flat area is superposed with the plate flat area and the core curved area is superposed with the plate curved area.

### CROSS-REFERENCE TO RELATED APPLICATION

This application claims the priority benefits of U.S. provisional application Ser. No. 61/497,033, filed on Jun. 14, 2011. The entirety of the above-mentioned patent applications is hereby incorporated by reference herein and made a part of this specification.

### BACKGROUND OF THE INVENTION

1. Field of the Invention

The present invention generally relates to a three-dimensional workpiece, and more particularly, to a three-dimensional workpiece using composite material.

2. Description of Related Art

With the advancement in semiconductor devices and display technology, electronic products are being developed toward small size, multi-function and ease of carry. Common portable electronic products include notebook computers, tablet computers and mobile phones.

In order to reduce weight and increase structural strength of casings of the portable electronic products, an existing method is using a composite material of fiber and metal to manufacture the casings. The casing adopting composite materials currently contains two metal plates and a core layer, in which the core layer is located between the two metal plates and bound with the two metal plates.

In order to reduce the weight of the casing, the core layer herein has multiple openings, and these openings cover the entire surface of the core layer. However, the casing after its three-dimensional shaping may have unsmooth-appearance defect due to the openings of the core layer at casing's bent place.

### SUMMARY OF THE INVENTION

Accordingly, the present invention is directed to a three-dimensional workpiece able to maintain its smooth appearance at the bent place thereof.

The present invention provides a three-dimensional workpiece, which includes a first ductile plate, a second ductile plate and a core layer. The core layer is located between the first ductile plate and the second ductile plate. The first ductile plate, the second ductile plate and the core layer are bound together and have a three-dimensional shape. The first ductile plate has a plate flat area and a plate curved area. The core layer has a core flat area and a core curved area. The core flat area is superposed with the plate flat area and the core curved area is superposed with the plate curved area.

Based on the description above, the present invention can reduce the weight of the three-dimensional workpiece by forming openings on the core flat area of the core layer and thus ensure the smooth-appearance of the first ductile plate by using the core flat area of the core layer.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is an exploded view of a three-dimensional workpiece prior to three-dimensionally shaping according to an embodiment of the present invention.

FIG. 2A is a perspective view of a portion of the three-dimensional workpiece of FIG. 1 prior to three-dimensionally shaping.

FIG. 2B is a perspective view of the portion of the three-dimensional workpiece of FIG. 2A prior to three-dimensionally shaping.

FIG. 3A is a perspective view of the portion of the three-dimensional workpiece of FIG. 2A after three-dimensionally shaping.

FIG. 3B is a perspective view of the portion of the three-dimensional workpiece of FIG. 3A after three-dimensionally shaping.

FIG. 4 is a perspective view of a core layer according to another embodiment of the present invention.

FIG. 5 is an exploded view of a core layer divided into two independent parts according to yet another embodiment of the present invention.

### DESCRIPTION OF THE EMBODIMENTS

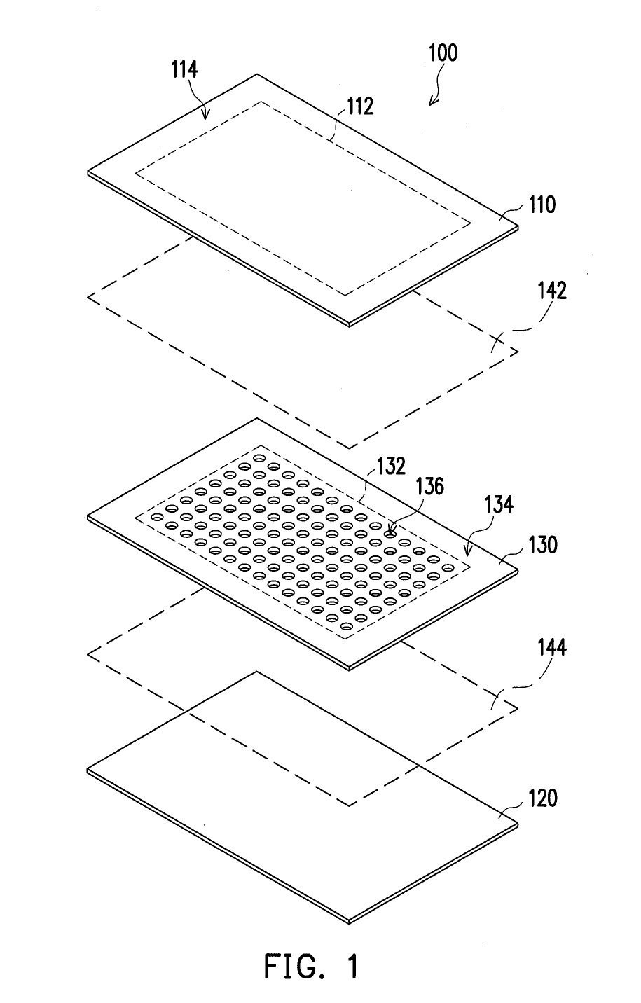

FIG. 1 is an exploded view of a three-dimensional workpiece prior to three-dimensionally shaping according to an embodiment of the present invention. Referring to FIG. 1, a three-dimensional workpiece 100 of the embodiment includes a first ductile plate 110, a second ductile plate 120 and a core layer 130. The core layer 130 is located between the first ductile plate 110 and the second ductile plate 120. The first ductile plate 110, the second ductile plate 120 and the core layer 130 are bound together to form a sandwich-like structure. In the embodiment, the first ductile plate 110 can be adhered onto the core layer 130 via an adhesive layer 142, while the second ductile plate 120 can be adhered onto the core layer 130 via another adhesive layer 144.

In the embodiment, the first ductile plate 110 and the second ductile plate 120 can be metal plate, ductile material plate containing metal or prepreg, in which the material of the prepreg can be plant fiber, glass fiber or carbon fiber. When both the first ductile plate 110 and the second ductile plate 120 are metal plates, the metal plate can be stainless steel plate (SUS plate), aluminium plate or tin-plated steel plate (SPTE). In addition, the core layer 130 can be mylar/film, fiber braid layer or prepreg, in which the mylar/film can be plastic one and the material of the fiber braid layer or the prepreg can be plant fiber, glass fiber or carbon fiber.

Depending on different product designs, the core layer 130 may be a core layer formed of multiple material layers or a single material layer. In addition, to meet the demand of product appearance or structure strength, the core layer 130 may have a uniform thickness or a non-uniform thickness. The first ductile plate 110 and the second ductile plate 120 may have a uniform thickness or a non-uniform thickness as well. When the adopted core layer 130 is a prepreg, the first ductile plate 110 and the second ductile plate 120 may be respectively and directly bound onto the prepreg (the adopted core layer 130) through the pre-impregnated liquid on the prepreg (the adopted core layer 130), without the need of additional adhesive layer.

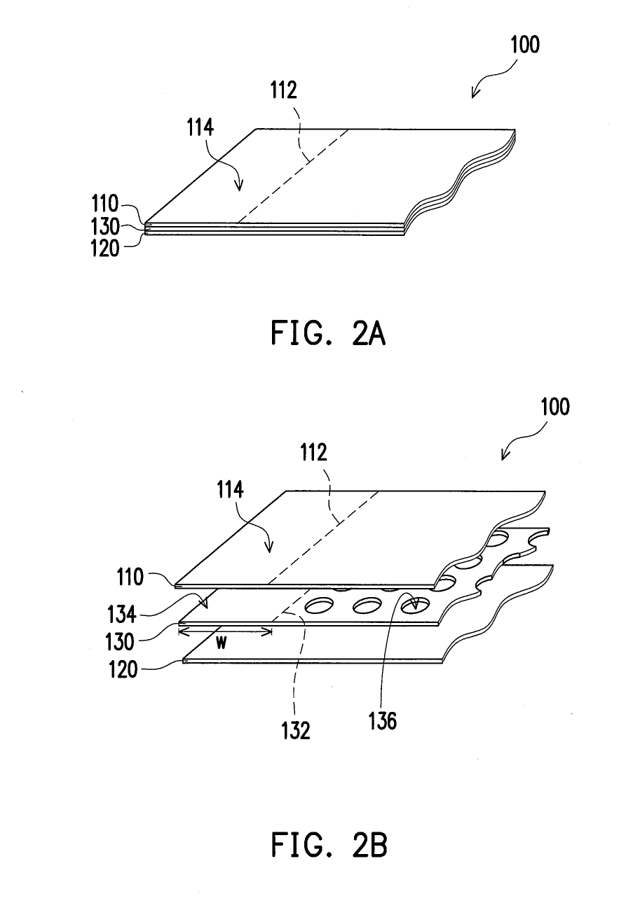

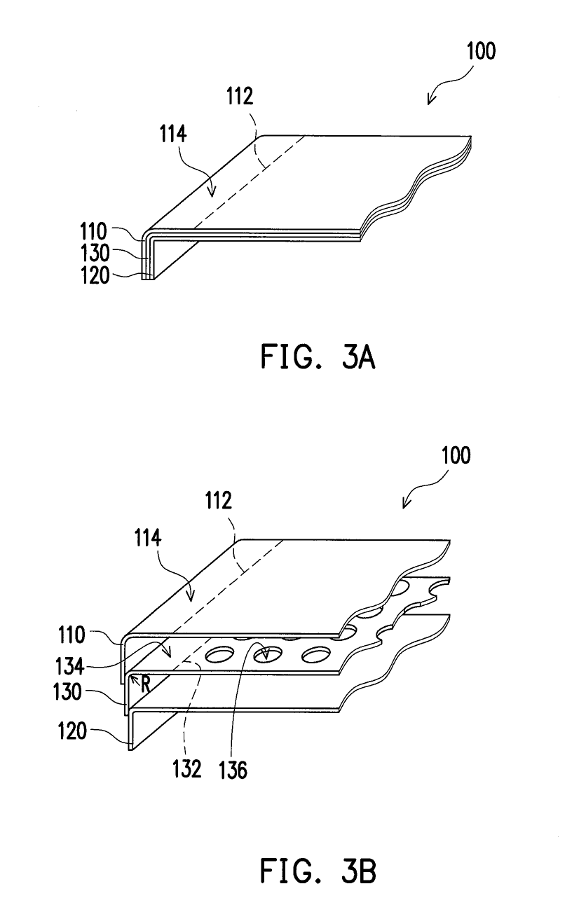

FIG. 2A is a perspective view of a portion of the three-dimensional workpiece of FIG. 1 prior to three-dimensionally shaping and FIG. 2B is a perspective view of the portion of the three-dimensional workpiece of FIG. 2A prior to three-dimensionally shaping. Referring to FIGS. 2A and 2B, the first ductile plate 110 and the second ductile plate 120 have respectively a plate flat area 112 and a plate curved area 114. The plate curved areas 114 are bent during three-dimensionally shaping thereof (as shown by FIGS. 2A-3A). In addition, the core layer 130 has a core flat area 132 and a core curved area 134. For lightening the three-dimensional workpiece after shaping, the core flat area 132 of the core layer 130 usually has a plurality of openings 136 and the openings 136 are in honeycomb-like arrangement. The core flat area 132 of the core layer 130 is superposed with the plate flat area 112 of the first ductile plate 110, and the core curved area 134 is superposed with the plate curved area 114. In the embodiment, the core curved area 134 of the core layer 130 may be a solid area without any opening.

FIG. 3A is a perspective view of the portion of the three-dimensional workpiece of FIG. 2A after three-dimensionally shaping, and FIG. 3B is a perspective view of the portion of the three-dimensional workpiece of FIG. 3A after three-dimensionally shaping. Referring to FIGS. 3A and 3B, when the first ductile plate 110, the second ductile plate 120 and the core layer 130 are bound together under a force to form the three-dimensional workpiece 100, the edge area of the three-dimensional workpiece 100 is curved with a smooth bending edge surface, i.e., maintain the smooth appearance of the first ductile plate 110.

When the first ductile plate 110, the second ductile plate 120 and the core layer 130 have three-dimensionally shaped, the core flat area 132 is superposed with the plate flat area 112, and the weight of the core layer 130 is reduced by forming the openings 136 on the core flat area 132. In addition, the core curved area 134 is superposed with the plate curved area 114, and by the design of the core curved area 134, the plate curved area 114 of the first ductile plate 110, in particular the place at the position of ridge line, keeps a smooth appearance.

According to the real requirement, in the embodiment, when the plate curved area 114 surrounds the plate flat area 112, the core curved area 134 may accordingly surround the core flat area 132. With different product designs, the core curved area 134 may form a curved corner with a radius R after bending, while the width w of the core layer 130 at the core curved area 134 (referring to FIG. 2B) is usually greater than the circular length corresponding to the curved corner (2πR) so as to maintain the workpiece after the bending in surface smooth appearance.

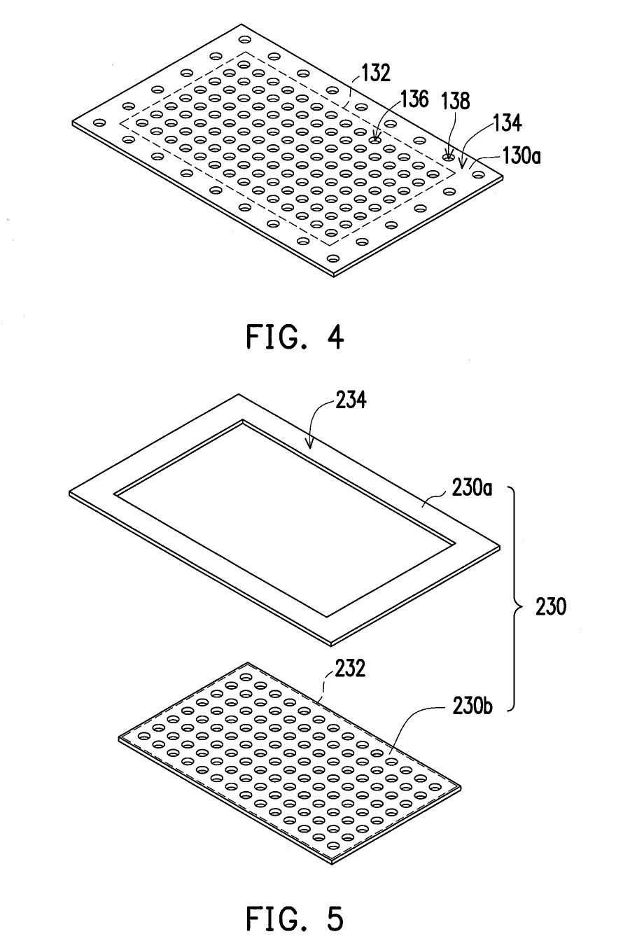

FIG. 4 is a perspective view of a core layer according to another embodiment of the present invention. Referring to FIG. 4, the core layer 130a herein is similar to the core layer 130 in FIG. 1, but in addition to having the openings 136 on the core flat area 132, the core layer 130a further has a plurality of openings 138 at the core curved area 134. In other words, the core layer 130a has a plurality of openings 136 and openings 138, in which a part of the openings (the openings 136) is distributed on the core flat area 132 while the rest part of the openings is distributed on the core curved area 134 (the openings 138).

In the embodiment, the aspect ratio of the core curved area 134 on the core layer 130a is less than the aspect ratio of the core flat area 132 so that the plate curved area after the bending (such as the mark 114 in FIG. 3A or 3B) has a smooth appearance. However, depending on different product designs, the distribution density of the openings on the core flat area 132 of the core layer 130a may be greater than or less than the distribution density of the openings on the core curved area 134, and the hole diameter of the openings on the core flat area 132 may be greater than or less than the hole diameter of the openings on the core curved area 134.

FIG. 5 is an exploded view of a core layer divided into two independent parts according to yet another embodiment of the present invention. Referring to FIG. 5, different from the core layer 130 of FIG. 1 where the core layer 130 is a single part, the core layer 230 of the embodiment includes two parts 230a and 230b respectively with an independent structure. In addition to the independent structure feature, the parts 230a and 230b respectively form the core flat area 232 and the core curved area 234. In the embodiment, depending on the real requirement, the core curved area 234 may surround the core flat area 232, and the part 230b may include the core curved area 234 and a part of the core flat area 232 depending on the different product designs, which the present invention is not limited to.

In summary, the present invention may reduce the weight of the three-dimensional workpiece by forming openings on the core flat area of the core layer and thus ensure the smooth-appearance of the first ductile plate by specifying the aspect ratio of the core curved area less than the aspect ratio of the core flat area.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A three-dimensional workpiece, comprising:
a first ductile plate;
a second ductile plate; and
a core layer, located between the first ductile plate and the second ductile plate and having a core flat area and a core curved area, wherein an aperture ratio of the core curved area is less than an aperture ratio of the core flat area, and when the first ductile plate, the second ductile plate and the core layer are bound under a force to form the three-dimensional workpiece, an edge area of the three-dimensional workpiece is curved with a smooth bending edge surface.

2. The three-dimensional workpiece as claimed in claim 1, wherein the first ductile plate has a plate flat area and a plate curved area, the plate flat area is superposed with the core flat area, and the plate curved area is superposed with the core curved area.

3. The three-dimensional workpiece as claimed in claim 1, wherein the core layer has a plurality of openings, the openings are distributed at the core flat area, and the openings are in honeycomb-like arrangement.

4. The three-dimensional workpiece as claimed in claim 1, wherein the core curved area is a solid area.

5. The three-dimensional workpiece as claimed in claim 1, wherein the core curved area surrounds the core flat area.

6. The three-dimensional workpiece as claimed in claim 1, wherein the core layer has a plurality of openings, a part of the openings is distributed at the core flat area, and the rest part of the openings is distributed at the core curved area.

7. The three-dimensional workpiece as claimed in claim 6, wherein distribution density of the openings on the core curved area is less than or greater than distribution density of the openings on the core flat area.

8. The three-dimensional workpiece as claimed in claim 6, wherein hole diameter of the openings on the core curved area is less than or greater than hole diameter of the openings on the core flat area.

9. The three-dimensional workpiece as claimed in claim 1, wherein the core layer comprises two parts, the parts have respectively an independent structure, and the parts respectively form the core flat area and the core curved area.

10. The three-dimensional workpiece as claimed in claim 1, wherein each of the first ductile plate and the second ductile plate is adhered onto the core layer through an adhesive layer.

11. The three-dimensional workpiece as claimed in claim 1, wherein material of the first ductile plate and the second ductile plate is metal plate, ductile material plate containing metal or prepreg.

12. The three-dimensional workpiece as claimed in claim 11, wherein material of the prepreg comprises plant fiber, glass fiber or carbon fiber.

13. The three-dimensional workpiece as claimed in claim 11, wherein the metal. plate is SPTE, aluminium plate, or SUS plate.

14. The three-dimensional workpiece as claimed in claim 1, wherein the core layer is a film, a fiber braid layer or a prepreg.

15. The three-dimensional workpiece as claimed in claim 14, wherein the film is a plastic film.

16. The three-dimensional workpiece as claimed in claim 14, wherein material of the fiber braid layer or the prepreg comprises plant fiber, glass fiber or carbon fiber.

17. The three-dimensional workpiece as claimed in claim 1, wherein the core curved area after bending forms a curved corner and width of the core layer is greater than circular length corresponding to the curved corner.

18. The three-dimensional workpiece as claimed in claim 1, wherein the core layer has a non-uniform thickness and is formed of a plurality of material layers or a single material layer.

19. The three-dimensional workpiece as claimed in claim 1, wherein each of the first ductile plate and the second ductile plate has a non-uniform thickness.
